(19) United States
(12) Patent Application Publication
(10) Pub. No.: US 2025/0216286 A1
(43) Pub. Date: Jul. 3, 2025

(54) DEVICE FOR TESTING GAS TIGHTNESS OF CRYOGENIC THERMAL INSULATION MODULE AND GAS FLUIDITY THEREIN

(71) Applicants: SHANGHAI JIAO TONG UNIVERSITY, Shanghai (CN); HUDONG-ZHONGHUA SHIPBUILDING (GROUP) CO., LTD., Shanghai (CN)

(72) Inventors: Guang YANG, Shanghai (CN); Wei SONG, Shanghai (CN); Wei LUO, Shanghai (CN); Jingyi WU, Shanghai (CN); Xiaoci LI, Shanghai (CN); Aifeng CAI, Shanghai (CN); Chunyu LI, Shanghai (CN); Meng YU, Shanghai (CN); Lixia LIU, Shanghai (CN)

(21) Appl. No.: 19/024,228

(22) Filed: Jan. 16, 2025

Related U.S. Application Data
(63) Continuation-in-part of application No. PCT/CN2024/084335, filed on Mar. 28, 2024.

(30) Foreign Application Priority Data
Dec. 29, 2023 (CN) 202311863064.X

(51) Int. Cl. G01M 3/32

(52) U.S. Cl. CPC G01M 3/32

(57) ABSTRACT

A device for testing gas tightness of a cryogenic thermal insulation module and gas fluidity therein includes a gas/liquid inlet module, a gas/liquid discharge module and a thermal insulation module. The gas/liquid inlet module includes an inner-space liquid nitrogen inlet valve, an outer-space liquid nitrogen inlet valve, a low-pressure pressure control module, an inner-space high-pressure pressure control module, an outer-space high-pressure pressure control module, a buffer tank, a pressure relief valve and a filter, which are connected by a pipe. The gas/liquid discharge module includes a liquid/gaseous nitrogen discharge valve, an inner-space vent valve and an outer-space vent valve, which are connected by a pipe. An outlet of the gas/liquid inlet module is connected to an inlet of the thermal insulation module, and inlet of the gas/liquid discharge module is connected to an outlet of the thermal insulation module. The present invention can be used to inspect and investigate the tightness of a thermal insulation module under cryogenic and ambient conditions and to test and investigate gas fluidity therein.

### RELATED APPLICATIONS

This application is a continuation-in-part (CIP) application claiming benefit of PCT/CN2024/084335 filed on Mar. 28, 2024, which claims priority to Chinese Patent Application No. 202311863064.X filed on Dec. 29, 2023, the disclosures of which are incorporated herein in their entirety by reference.

### FIELD OF THE INVENTION

The present invention relates to the field of cryogenic thermal insulation module testing technology, and more particularly to a device for testing gas tightness of a cryogenic thermal insulation module and gas fluidity therein.

### DESCRIPTION OF THE PRIOR ART

Continual research and innovative improvement of various cryogenic techniques, such as performance testing of thermal insulation materials, design of thermal insulation structures and cryogenic performance testing, are indispensable for innovations and the development of systems and equipment for the storage and transportation of cryogenic media (e.g., liquefied natural gas (LNG), liquid oxygen, liquid nitrogen, liquid hydrogen, liquid helium, etc.) Performance testing of cryogenic containment systems is the basis for the verification of critical technologies and crucial systems and provides necessary support for breakthroughs, research and development (R&D), prototyping and verification in related techniques. Sealing conditions in cryogenic environments are an important performance indicator for thermal insulation modules and are important for ensuring operating safety of cryogenic containment systems. Moreover, good gas fluidity in given areas and directions within a thermal insulation module can ensure desirable replacement of water vapor, oxygen and other non-inert gases. A device for testing gas tightness of a cryogenic thermal insulation module and gas fluidity therein is designed mainly to inspect its tightness in and adaptability to a cryogenic environment, test and investigate gas fluidity in its interior, investigate internal dew-point temperature and moisture content profiles during inert gas replacement, thereby providing guidance for structural design of the thermal insulation module and associated machining and installation processes, enhancing the reliability of independent R&D achievements and offering a technical basis for large storage tanks, LNG vessels and other practical applications.

According to a literature search, to date, there have been no disclosed systems for testing gas tightness of a cryogenic thermal insulation module and gas fluidity therein, or similar testing systems. Therefore, there is still a lack of techniques for testing tightness of a thermal insulation module system in a cryogenic containment system and gas fluidity therein under cryogenic and ambient conditions. There is a high demand for developing devices suitable for testing gas tightness of a cryogenic thermal insulation module and gas fluidity therein, which can perform high-quality, reliable, efficient, low-cost tests on tightness of a cryogenic containment system and gas fluidity therein under multiple working conditions.

Therefore, those skilled in the art are directing their effort toward developing devices suitable for testing gas tightness of a cryogenic thermal insulation module and gas fluidity therein, which can inspect its tightness in and adaptability to cryogenic and ambient conditions and test and investigate its internal gas fluidity in its interior.

### SUMMARY OF THE INVENTION

In view of the above-described disadvantages of the prior art, the problems sought to be solved by the present invention are:
1. A lack of techniques for testing tightness of a thermal insulation module system in a cryogenic containment system and gas fluidity therein under cryogenic and ambient conditions.
2. A need for multiple pressure gradients and independent pressure control in testing of tightness of a thermal insulation module system in a cryogenic containment system and gas fluidity therein under cryogenic and ambient conditions.
3. Testing of tightness of a thermal insulation module system in a containment system and gas fluidity therein under a cryogenic condition at a temperature as low as −196° C.
4. Testing of tightness of a thermal insulation module system in a containment system and gas fluidity therein for multiple purposes and under various combinations of testing conditions.
5. Thermal insulation modules of a wide variety of sizes and styles in currently available containment systems, as well as distinct interface locations therein.

To this end, the present invention provides a device for testing gas tightness of a cryogenic thermal insulation module and gas fluidity therein, comprising a gas/liquid inlet module, a gas/liquid discharge module and a thermal insulation module, the gas/liquid inlet module comprising an inner-space liquid nitrogen inlet valve, an outer-space liquid nitrogen inlet valve, a low-pressure pressure control module, an inner-space high-pressure pressure control module, an outer-space high-pressure pressure control module, a buffer tank, a pressure relief valve and a filter, which are connected by a pipe, the gas/liquid discharge module comprising a liquid/gaseous nitrogen discharge valve, an inner-space vent valve and an outer-space vent valve, which are connected by a pipe, outlets of the inner-space liquid nitrogen inlet valve, the low-pressure pressure control module and the inner-space high-pressure pressure control module connected in parallel and connected to an inlet of an inner space of the thermal insulation module, outlets of the outer-space high-pressure pressure control module and the outer-space liquid nitrogen inlet valve connected in parallel and connected to an inlet of an outer space of the thermal insulation module, inlets of the low-pressure pressure control module, the inner-space high-pressure pressure control module and the outer-space high-pressure pressure control module connected in parallel, sequentially connected to the buffer tank, the pressure relief valve and the filter and then connected to a gaseous nitrogen inflow interface, inlets of the inner-space liquid nitrogen inlet valve and the outer-space liquid nitrogen inlet valve each connected to the liquid nitrogen inflow interface, an outlet of the inner space of the thermal insulation module connected to an inlet of the inner-space vent valve, an outlet of the outer space of the thermal insulation module connected to an inlet of the outer-space vent valve, outlets of the inner-space vent valve and the outer-space vent valve connected in parallel and connected to a liquid/gaseous nitrogen discharge interface via the liquid/gaseous nitrogen discharge valve.

Further, the gas/liquid discharge module may further comprise a negative-pressure air evacuation valve, wherein the outlets of the inner-space vent valve and the outer-space vent valve are connected in parallel by the pipe, and are connected to a negative-pressure gas evacuation interface via the negative-pressure air evacuation valve.

Further, the low-pressure pressure control module may comprise a low-pressure pressure controller outlet valve, a low-pressure pressure controller inlet valve, a low-pressure pressure controller, which are connected by the pipe, wherein an outlet of the low-pressure pressure controller outlet valve serves as the outlet of the low-pressure pressure control module, the low-pressure pressure controller outlet valve is connected to an outlet of the low-pressure pressure controller inlet valve via the low-pressure pressure controller, and an inlet of the low-pressure pressure controller inlet valve serves as the inlet of the low-pressure pressure control module.

Further, the inner-space high-pressure pressure control module may comprise an inner-space high-pressure pressure controller outlet valve, an inner-space high-pressure pressure controller inlet valve and an inner-space high-pressure pressure controller, which are connected by the pipe, wherein an outlet of the inner-space high-pressure pressure controller outlet valve serves as the outlet of the inner-space high-pressure pressure control module, the inner-space high-pressure pressure controller outlet valve is connected to an outlet of the inner-space high-pressure pressure controller inlet valve via the inner-space high-pressure pressure controller, and an inlet of the inner-space high-pressure pressure controller inlet valve serves as the inlet of the inner-space high-pressure pressure control module.

Further, the outer-space high-pressure pressure control module may comprise an outer-space high-pressure pressure controller outlet valve, an outer-space high-pressure pressure controller inlet valve and an outer-space high-pressure pressure controller, which are connected by the pipe, wherein an outlet of the outer-space high-pressure pressure controller outlet valve serves as the outlet of the outer-space high-pressure pressure control module, the outer-space high-pressure pressure controller outlet valve is connected to an outlet of the outer-space high-pressure pressure controller inlet valve via the outer-space high-pressure pressure controller, and an inlet of the outer-space high-pressure pressure controller inlet valve serves as the inlet of the outer-space high-pressure pressure control module.

Further, the outlets of the inner-space liquid nitrogen inlet valve, the low-pressure pressure control module and the inner-space high-pressure pressure control module may be connected in parallel and to the inlet of the inner-space of the thermal insulation module via a first pipe and an inner-space inlet metal hose, and the outlets of the outer-space high-pressure pressure control module and the outer-space liquid nitrogen inlet valve may be connected in parallel and to the inlet of the outer-space of the thermal insulation module via a second pipe and an outer-space inlet metal hose.

Further, the outlet of the inner space of the thermal insulation module may be connected to the inlet of the inner-space vent valve via a third pipe and an inner-space outlet metal hose, and the outlet of the outer space of the thermal insulation module may be connected to the inlet of the outer-space vent valve via a fourth pipe and an outer-space outlet metal hose.

Further, the outlet of the inner-space vent valve may be connected to one end of a fifth pipe, and the outlet of the outer-space vent valve may be connected to one end of a sixth pipe, wherein the other end of the fifth pipe and the other end of the sixth pipe are connected in parallel.

Further, the first pipe may be provided thereon with an inner-space inlet pressure sensor and an inner-space inlet temperature sensor, and the second pipe may be provided thereon with an outer-space inlet pressure sensor and an outer-space inlet temperature sensor.

Further, the first pipe may be further provided thereon with an inner-space inlet safety valve, and the second pipe may be further provided thereon with an outer-space inlet safety valve.

Further, the third pipe may be provided thereon with an inner-space outlet safety valve, and the fourth pipe may be provided thereon with an outer-space outlet safety valve.

Further, the fifth pipe may be provided thereon with an inner-space outlet temperature sensor, an inner-space outlet oxygen content sensor and an inner-space outlet dew-point thermometer, and the sixth pipe may be provided thereon with an outer-space outlet temperature sensor, an outer-space outlet oxygen content sensor and an outer-space outlet dew-point thermometer.

Further, the negative-pressure air evacuation valve, the liquid/gaseous nitrogen discharge valve, the inner-space vent valve, the outer-space vent valve, the inner-space liquid nitrogen inlet valve, the low-pressure pressure controller outlet valve, the inner-space high-pressure pressure controller outlet valve, the outer-space high-pressure pressure controller outlet valve and the outer-space liquid nitrogen inlet valve may be cryogenic valves operable at a temperature of −196° C.

Further, the inner-space vent valve, the outer-space vent valve, the inner-space liquid nitrogen inlet valve, the low-pressure pressure controller outlet valve, the inner-space high-pressure pressure controller outlet valve, the outer-space high-pressure pressure controller outlet valve and the outer-space liquid nitrogen inlet valve may be pneumatic valves.

Further, the negative-pressure air evacuation valve, the liquid/gaseous nitrogen discharge valve, the low-pressure pressure controller inlet valve, the inner-space high-pressure pressure controller inlet valve and the outer-space high-pressure pressure controller inlet valve may be solenoid valves.

Further, the negative-pressure air evacuation valve, the liquid/gaseous nitrogen discharge valve, the inner-space vent valve, the outer-space vent valve, the inner-space liquid nitrogen inlet valve, the low-pressure pressure controller outlet valve, the low-pressure pressure controller inlet valve, the inner-space high-pressure pressure controller outlet valve, the inner-space high-pressure pressure controller inlet valve, the outer-space high-pressure pressure controller outlet valve, outer-space high-pressure pressure controller inlet valve and the outer-space liquid nitrogen inlet valve may be fixed to the pipe by welding.

Further, the low-pressure pressure controller, the inner-space high-pressure pressure controller and the outer-space high-pressure pressure controller may be fixed to the pipe by vacuum coupling radius (VCR) seal interfaces.

Further, the inner-space outlet oxygen content sensor, the inner-space outlet dew-point thermometer, the outer-space outlet oxygen content sensor and the outer-space outlet dew-point thermometer may be fixed to the pipe by VCR seal interfaces.

Further, the inner-space inlet pressure sensor, the inner-space inlet temperature sensor, the outer-space inlet pressure sensor and the outer-space inlet temperature sensor may be fixed to the pipe by threaded connections.

Further, the first pipe, the second pipe, the third pipe and the fourth pipe may be stainless steel pipes.

Further, the inner-space inlet metal hose, the outer-space inlet metal hose, the inner-space outlet metal hose and the outer-space outlet metal hose may be fixed to the thermal insulation module by vacuum coupling radius seal interfaces, and the inner-space inlet metal hose, the outer-space inlet metal hose, the inner-space outlet metal hose and the outer-space outlet metal hose may be fixed to the first pipe, the second pipe, the third pipe and the fourth pipe by welding.

Further, both the inner and outer spaces may be continuous channels with a sealed boundary defined along a seam of the thermal insulation module.

Compared with the prior art, the present invention primarily has the following advantages:
(1) It establishes a technique for testing tightness and gas fluidity in an interior space under cryogenic (in a temperature range of liquid nitrogen) and ambient (in a room temperature range) conditions. Following the principles of cryogenic fluid transfer control, tightness of a thermal insulation module in a cryogenic containment system and gas fluidity therein can be tested using different processes and under different conditions. This is the very first report about testing tightness of a thermal insulation module in a cryogenic containment system and gas fluidity therein under cryogenic (in a temperature range of liquid nitrogen) and ambient (in a room temperature range) conditions.
(2) It introduces multiple stages of precise pressure control provided by a pressure relief valve connected in series with three high-precision pressure controllers. After a first stage of pressure reduction, precise pressure control is applied, and input pressures of cryogenic and ambient fluids are controlled independently. In this way, independent precise pressure control of inner and outer spaces of a thermal insulation module in a cryogenic containment system can be achieved.
(3) It introduces liquid nitrogen input and process control. Liquid nitrogen at −196° C. is allowed to directly flow into a thermal insulation module of a containment system to chill the thermal insulation module of the containment system by means of its own latent heat through heat exchange. In this way, the thermal insulation module in the cryogenic containment system can be pre-chilled, as required by testing of tightness of the thermal insulation module in the cryogenic containment system under cryogenic conditions.
(4) The pressure controllers are connected in parallel to and thereby combined with valves for controlling the flow direction of a fluid. Depending on types and processes, tests with different targets can be carried out simultaneously or in parallel. Therefore, the single device and system can be used to carry out various tests with increased efficiency at lower cost.
(5) Connections in the device are essentially established with metal hoses and VCR seal interfaces. Taking advantage of spatial compensation capabilities of the metal hoses, the device is compatible with various thermal insulation modules in containment systems, which are of different sizes and have different interface locations. Since the VCR seal interfaces are detachable, the connected components in the device can be removed for replacement. Thus, the device can be used to test tightness of thermal insulation modules of various sizes in cryogenic containment systems and gas fluidity therein, and such thermal insulation modules can be easily replaced and efficiently detached.

For a full understanding of the objects, features and effects of the present application, the concept, structural details and resulting technical effects will be further described with reference to the accompanying drawings.

### BRIEF DESCRIPTION OF DRAWINGS

FIG. 1 shows the composition of a system according to an embodiment of the present invention.

FIG. 2 is a schematic structural view of a gas/liquid discharge module according to an embodiment of the present invention.

FIG. 3 is a schematic structural view of a gas/liquid inlet module according to an embodiment of the present invention.

FIG. 4 is a schematic structural view of a thermal insulation module according to an embodiment of the present invention.

### DETAILED DESCRIPTION OF THE PREFERRED EMBODIMENTS

A few preferred embodiments of the present application are described below with reference to the drawings accompanying this specification so that the techniques disclosed herein become more apparent and better understood. The present application may be embodied in many different forms, and its scope sought to be protected hereby is not limited only to the embodiments disclosed herein.

Throughout the accompanying drawings, structurally identical parts are indicated with the identical reference numerals, and structurally or functionally similar components are indicated with similar reference numerals.

An embodiment of the present invention provides a system, which can be used to test gas tightness of a cryogenic containment system and gas fluidity therein.

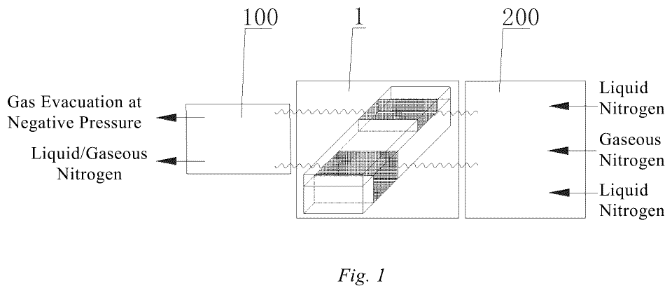

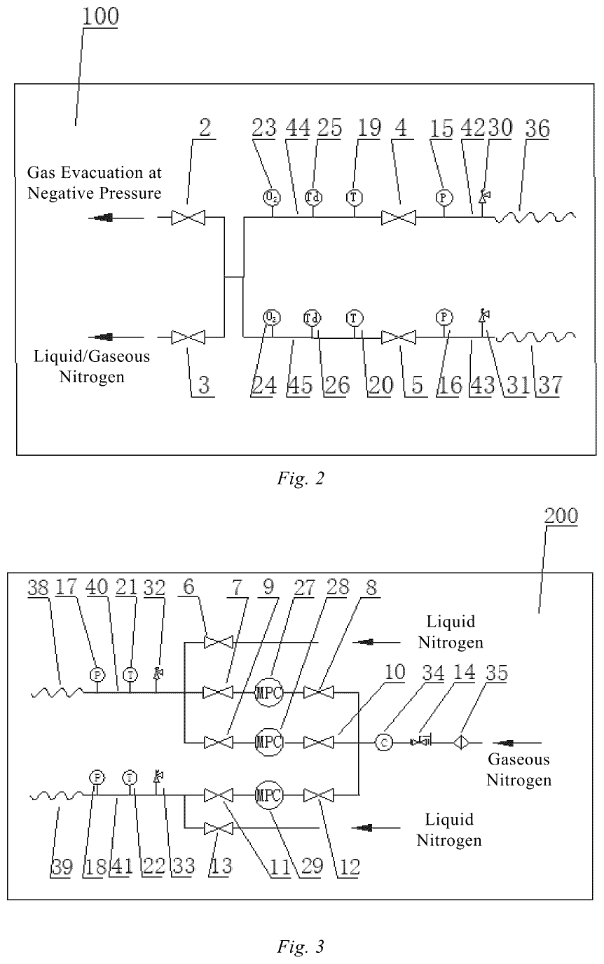

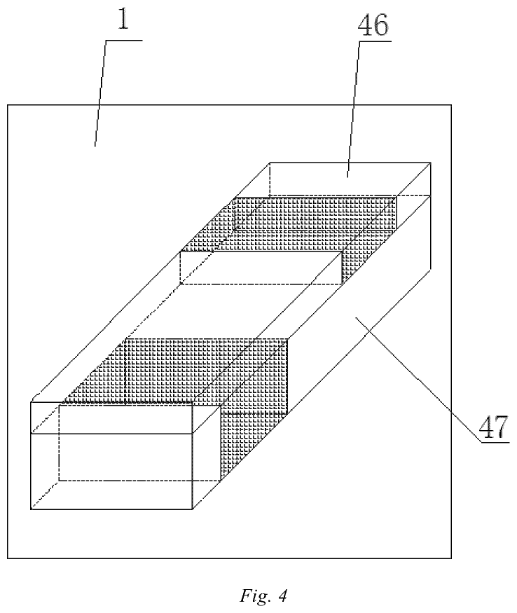

A negative-pressure air evacuation valve 2, a liquid/gaseous nitrogen discharge valve 3, an inner-space vent valve 4, an outer-space vent valve 5, an inner-space liquid nitrogen inlet valve 6, a low-pressure pressure controller outlet valve 7, a low-pressure pressure controller inlet valve 8, an inner-space high-pressure pressure controller outlet valve 9, an inner-space high-pressure pressure controller inlet valve 10, an outer-space high-pressure pressure controller outlet valve 11, an outer-space high-pressure pressure controller inlet valve 12, an outer-space liquid nitrogen inlet valve 13, a pressure relief valve 14, an inner-space outlet pressure sensor 15, an outer-space outlet pressure sensor 16, an inner-space inlet pressure sensor 17, an outer-space inlet pressure sensor 18, an inner-space outlet temperature sensor 19, an outer-space outlet temperature sensor 20, an inner-space inlet temperature sensor 21, an outer-space inlet temperature sensor 22, an inner-space outlet oxygen content sensor 23, an outer-space outlet oxygen content sensor 24, an inner-space outlet dew-point thermometer 25, an outer-space outlet dew-point thermometer 26, the low-pressure pressure controller 27, the inner-space high-pressure pressure controller 28, the outer-space high-pressure pressure controller 29, an inner-space outlet safety valve 30, an outer-space outlet safety valve 31, an inner-space inlet safety valve 32, an outer-space inlet safety valve 33, a buffer tank 34 and a filter 35 are connected by pipes as shown in FIGS. 1 to 4, and connected to a thermal insulation module 1 by an inner-space outlet metal hose 36, an outer-space outlet metal hose 37, an inner-space inlet metal hose 38 and an outer-space inlet metal hose 39. Specifically, the low-pressure pressure controller outlet valve 7, the low-pressure pressure controller 27 and the low-pressure pressure controller inlet valve 8 are sequentially connected in series and constitute a low-pressure pressure control module. The inner-space high-pressure pressure controller outlet valve 9, the inner-space high-pressure pressure controller 28 and the inner-space high-pressure pressure controller inlet valve 10 are sequentially connected in series and constitute an inner-space high-pressure pressure control module. The outer-space high-pressure pressure controller outlet valve 11, the outer-space high-pressure pressure controller 29 and the outer-space high-pressure pressure controller inlet valve 12 are sequentially connected in series and constitute an outer-space high-pressure pressure control module. The inner-space liquid nitrogen inlet valve 6, the outer-space liquid nitrogen inlet valve 13, the low-pressure pressure control module, the inner-space high-pressure pressure control module, the outer-space high-pressure pressure control module, the buffer tank 34, the pressure relief valve 14 and the filter 35 constitute a gas/liquid inlet module 200. The negative-pressure air evacuation valve 2, the liquid/gaseous nitrogen discharge valve 3, the inner-space vent valve 4 and the outer-space vent valve 5 constitute a gas/liquid discharge module 100. An outlet of the gas/liquid inlet module 200 is connected to an inlet of the thermal insulation module 1. An inlet of the gas/liquid discharge module 100 is connected to an outlet of the thermal insulation module 1.

Outlets of the low-pressure pressure controller outlet valve 7, the inner-space liquid nitrogen inlet valve 6 and the inner-space high-pressure pressure controller outlet valve 9 are connected in parallel and connected to a first pipe 40. The first pipe 40 is connected to an inlet of an inner space 46 by the inner-space inlet metal hose 38. The outer-space high-pressure pressure controller outlet valve 11 and an outlet of the outer-space liquid nitrogen inlet valve 13 are connected in parallel and connected to an inlet of an outer space 47. An outlet of the inner space 46 is connected to one end of the inner-space outlet metal hose 36, and the other end of the inner-space outlet metal hose 36 is connected to an inlet of the inner-space vent valve 4 by a third pipe 42. An outlet of the inner-space vent valve 4 is connected to the negative-pressure air evacuation valve 2 and the liquid/gaseous nitrogen discharge valve 3 by a fifth pipe 44. An outlet of the outer space 47 is connected to one end of the outer-space outlet metal hose 37, and the other end of the outer-space outlet metal hose 37 is connected to an inlet of the outer-space vent valve 5 by a fourth pipe 43. An outlet of the outer-space vent valve 5 is connected to the negative-pressure air evacuation valve 2 and the liquid/gaseous nitrogen discharge valve 3 by a sixth pipe 45.

All the valves are fixed to the pipes by welding. All the pressure controllers, all the dew-point thermometers and all the oxygen content sensors are fixed to the pipes by VCR seal interfaces. All the pressure sensors and temperature sensors are fixed to the pipes by threaded connections. All the metal hoses are fixed to the thermal insulation module by VCR seal interfaces. All the metal hoses are fixed to the pipes by welding.

The negative-pressure air evacuation valve 2, the liquid/gaseous nitrogen discharge valve 3, the inner-space vent valve 4, the outer-space vent valve 5, the inner-space liquid nitrogen inlet valve 6, the low-pressure pressure controller outlet valve 7, the inner-space high-pressure pressure controller outlet valve 9, the outer-space high-pressure pressure controller outlet valve 11 and the outer-space liquid nitrogen inlet valve 13 are cryogenic valves operable at a temperature of −196° C.

The inner-space vent valve 4, the outer-space vent valve 5, the inner-space liquid nitrogen inlet valve 6, the low-pressure pressure controller outlet valve 7, the inner-space high-pressure pressure controller outlet valve 9, the outer-space high-pressure pressure controller outlet valve 11 and the outer-space liquid nitrogen inlet valve 13 are pneumatic valves. The negative-pressure air evacuation valve 2, the liquid/gaseous nitrogen discharge valve 3, the low-pressure pressure controller inlet valve 8, the inner-space high-pressure pressure controller inlet valve 10 and the outer-space high-pressure pressure controller inlet valve 12 are solenoid valves.

According to the present embodiment, operation is possible in at least five modes:

### a. Mode of Testing Ambient Tightness (in Room Temperature Range) of Thermal Insulation Module in Cryogenic Containment System

The low-pressure pressure controller outlet valve 7 and the low-pressure pressure controller inlet valve 8 are opened and the inner-space vent valve 4 is closed, allowing gaseous nitrogen to pass through the filter 35 and then experience a first stage of pressure reduction in the pressure relief valve 14. After that, its flow is stabilized in the buffer tank 34, and its pressure is precisely controlled in the low-pressure pressure controller 27. It then enters the inner space of the thermal insulation module 1, and after a stable pressure is reached, the inner-space outlet pressure sensor 15 and the inner-space inlet pressure sensor 17 are used to monitor system pressure variation. Subsequently, a value of the low-pressure pressure controller 27 is adjusted to change the system pressure. Repeated tests are carried at multiple values, obtaining ambient tightness test results of the thermal insulation module in the cryogenic containment system.

### b. Mode of Pre-Chilling Thermal Insulation Module in Cryogenic Containment System

The inner-space liquid nitrogen inlet valve 6, the outer-space liquid nitrogen inlet valve 13, the inner-space vent valve 4, the outer-space vent valve 5 and the liquid/gaseous nitrogen discharge valve 3 are opened, and the closed low-pressure pressure controller outlet valve 7, the inner-space high-pressure pressure controller outlet valve 9, the outer-space high-pressure pressure controller outlet valve 11 and the negative-pressure air evacuation valve 2 are closed. Openings of the inner-space liquid nitrogen inlet valve 6 and the outer-space liquid nitrogen inlet valve 13 are adjusted, and liquid nitrogen is slowly introduced to the thermal insulation module 1. Readings of the inner-space outlet temperature sensor 19, the outer-space outlet temperature sensor 20, the inner-space inlet temperature sensor 21 and the outer-space inlet temperature sensor 22 are monitored. When temperatures shown in the inner-space outlet temperature sensor 19 and the outer-space outlet temperature sensor 20 reach a temperature range of liquid nitrogen, it can be considered that pre-chilling of the thermal insulation module in the containment system is completed.

### c. Mode of Testing Cryogenic Tightness (in Temperature Range of Liquid Nitrogen) of Thermal Insulation Module in Cryogenic Containment System

When the pre-chilling of the thermal insulation module 1 is completed, the low-pressure pressure controller outlet valve 7 and the low-pressure pressure controller inlet valve 8 are opened and the inner-space vent valve 4, the inner-space liquid nitrogen inlet valve 6 and the outer-space liquid nitrogen inlet valve 13 are closed, allowing gaseous nitrogen to pass through the filter 35 and then experience a first stage of pressure reduction in the pressure relief valve 14. After that, it is subjected to flow stabilization in the buffer tank 34 and precise pressure control by the low-pressure pressure controller 27. It then enters the inner space of the thermal insulation module 1, and after a stable pressure is reached, the inner-space outlet pressure sensor 15 and the inner-space inlet pressure sensor 17 are used to monitor pressure variation in the system. Subsequently, a value of the low-pressure pressure controller 27 is adjusted to change the system pressure. Repeated tests are carried at multiple values, obtaining cryogenic tightness test results of the thermal insulation module in the cryogenic containment system.

### d. Mode of Testing Gas Fluidity in Inner Space of Thermal Insulation Module in Cryogenic Containment System

The liquid/gaseous nitrogen discharge valve 3, the inner-space vent valve 4, the inner-space high-pressure pressure controller outlet valve 9 and the inner-space high-pressure pressure controller inlet valve 10 are opened, and the low-pressure pressure controller outlet valve 7, the outer-space vent valve 5, the negative-pressure air evacuation valve 2, the inner-space liquid nitrogen inlet valve 6, the outer-space liquid nitrogen inlet valve 13 and the outer-space high-pressure pressure controller outlet valve 11 are closed. A pressure of gaseous nitrogen that has entered the system is preliminarily reduced by adjusting the pressure relief valve 14, and is then stabilized by passing through the buffer tank 34. After that, precise pressure control is applied by setting the inner-space high-pressure pressure controller 28 so that the gaseous nitrogen enters the inner space of the thermal insulation module 1 at a constant pressure. At the same time, values of the inner-space outlet oxygen content sensor 23 and the inner-space outlet dew-point thermometer 25 are monitored to evaluate moisture content variation of the structure during flow of the gas in the inner space of the thermal insulation module 1. Afterwards, a set value of the inner-space high-pressure pressure controller 28 is adjusted to change the system pressure, and the negative-pressure air evacuation valve 2 is opened to evacuate gaseous nitrogen remaining in the system. Repeated tests are carried at multiple values, obtaining testing results of gas fluidity in the inner space of the cryogenic containment system.

### e. Mode of Testing Gas Fluidity in Outer Space of Thermal Insulation Module in Cryogenic Containment System

The outer-space vent valve 5, the liquid/gaseous nitrogen discharge valve 3, the outer-space high-pressure pressure controller outlet valve 11 and the outer-space high-pressure pressure controller inlet valve 12 are opened, and the inner-space vent valve 4, the negative-pressure air evacuation valve 2, the inner-space liquid nitrogen inlet valve 6, the low-pressure pressure controller outlet valve 7, the inner-space high-pressure pressure controller outlet valve 9 and the outer-space liquid nitrogen inlet valve 13 are closed. A pressure of gaseous nitrogen that has entered the system is preliminarily reduced by adjusting the pressure relief valve 14, and is then stabilized by passing through the buffer tank 34. After that, precise pressure control is applied by setting the outer-space high-pressure pressure controller 29 so that the gaseous nitrogen enters the outer space of the thermal insulation module 1 at a constant pressure. At the same time, values of the outer-space outlet oxygen content sensor 24 and the outer-space outlet dew-point thermometer 26 are monitored to evaluate moisture content variation of the structure during flow of the gas in the outer space of the thermal insulation module 1. Afterwards, a set value of the outer-space high-pressure pressure controller 29 is adjusted to change the system pressure, and the negative-pressure air evacuation valve 2 is opened to evacuate gaseous nitrogen remaining in the system. Repeated tests are carried at multiple values, obtaining testing results of gas fluidity in the outer space of the cryogenic containment system.

### f. Mode of Testing Gas Fluidity in Inner and Outer Spaces of Thermal Insulation Module in Cryogenic Containment System in Parallel

The liquid/gaseous nitrogen discharge valve 3, the inner-space vent valve 4, the outer-space vent valve 5, the inner-space high-pressure pressure controller outlet valve 9, the inner-space high-pressure pressure controller inlet valve 10, the outer-space high-pressure pressure controller outlet valve 11 and the outer-space high-pressure pressure controller inlet valve 12 are opened, and the negative-pressure air evacuation valve 2, the inner-space liquid nitrogen inlet valve 6, the low-pressure pressure controller outlet valve 7 and the outer-space liquid nitrogen inlet valve 13 are closed. A pressure of gaseous nitrogen that has entered the system is preliminarily reduced by adjusting the pressure relief valve 14, and is then stabilized by passing through the buffer tank 34. After that, precise pressure control is applied by setting the inner-space high-pressure pressure controller 28 and the outer-space high-pressure pressure controller 29 so that the gaseous nitrogen enters the inner and outer spaces of the thermal insulation module 1 at constant pressures. At the same time, values of the inner-space outlet oxygen content sensor 23, the inner-space outlet dew-point thermometer 25, the outer-space outlet oxygen content sensor 24 and the outer-space outlet dew-point thermometer 26 are monitored to evaluate moisture content variations of the structure during flow of the gas in the inner and outer spaces of the thermal insulation module 1. Afterwards, set values of the inner-space high-pressure pressure controller 28 and the outer-space high-pressure pressure controller 29 are adjusted to change the system pressure, and the negative-pressure air evacuation valve 2 is opened to evacuate gaseous nitrogen remaining in the system. Repeated tests are carried at multiple values, obtaining testing results of gas fluidity in the outer space of the cryogenic containment system. Repeated tests are carried at multiple values, obtaining testing results of gas fluidity in the inner and outer space of the thermal insulation module in the cryogenic containment system.

Although a few preferred specific embodiments of the present application have been described in detail above, it will be understood that those of ordinary skill in the art can make various modifications and changes thereto based on the concept of the present application without exerting any creative effort. Accordingly, all variant embodiments that can be obtained by those skilled in the art through logical analysis, inference or limited experimentation in accordance with the concept of the present invention on the basis of the prior art are intended to fall within the scope as defined by the appended claims.

1. A device for testing gas tightness of a cryogenic thermal insulation module and gas fluidity therein, comprising a gas/liquid inlet module, a gas/liquid discharge module and a thermal insulation module, the gas/liquid inlet module comprising an inner-space liquid nitrogen inlet valve, an outer-space liquid nitrogen inlet valve, a low-pressure pressure control module, an inner-space high-pressure pressure control module, an outer-space high-pressure pressure control module, a buffer tank, a pressure relief valve and a filter, which are connected by a pipe, the gas/liquid discharge module comprising a liquid/gaseous nitrogen discharge valve, an inner-space vent valve and an outer-space vent valve, which are connected by a pipe, outlets of the inner-space liquid nitrogen inlet valve, the low-pressure pressure control module and the inner-space high-pressure pressure control module connected in parallel and connected to an inlet of an inner space of the thermal insulation module, outlets of the outer-space high-pressure pressure control module and the outer-space liquid nitrogen inlet valve connected in parallel and connected to an inlet of an outer space of the thermal insulation module, inlets of the low-pressure pressure control module, the inner-space high-pressure pressure control module and the outer-space high-pressure pressure control module connected in parallel, sequentially connected to the buffer tank, the pressure relief valve and the filter and then connected to a gaseous nitrogen inflow interface, inlets of the inner-space liquid nitrogen inlet valve and the outer-space liquid nitrogen inlet valve each connected to the liquid nitrogen inflow interface, an outlet of the inner space of the thermal insulation module connected to an inlet of the inner-space vent valve, an outlet of the outer space of the thermal insulation module connected to an inlet of the outer-space vent valve, outlets of the inner-space vent valve and the outer-space vent valve connected in parallel and connected to a liquid/gaseous nitrogen discharge interface via the liquid/gaseous nitrogen discharge valve.

2. The device of claim 1, wherein the gas/liquid discharge module further comprises a negative-pressure air evacuation valve, and the outlets of the inner-space vent valve and the outer-space vent valve are connected in parallel by the pipe, and are connected to a negative-pressure gas evacuation interface via the negative-pressure air evacuation valve.

3. The device of claim 2, wherein the low-pressure pressure control module comprises a low-pressure pressure controller outlet valve, a low-pressure pressure controller inlet valve, a low-pressure pressure controller, which are connected by the pipe, an outlet of the low-pressure pressure controller outlet valve serves as the outlet of the low-pressure pressure control module, the low-pressure pressure controller outlet valve is connected to an outlet of the low-pressure pressure controller inlet valve via the low-pressure pressure controller, and an inlet of the low-pressure pressure controller inlet valve serves as the inlet of the low-pressure pressure control module.

4. The device of claim 3, wherein the inner-space high-pressure pressure control module comprises an inner-space high-pressure pressure controller outlet valve, an inner-space high-pressure pressure controller inlet valve and an inner-space high-pressure pressure controller, which are connected by the pipe, an outlet of the inner-space high-pressure pressure controller outlet valve serves as the outlet of the inner-space high-pressure pressure control module, the inner-space high-pressure pressure controller outlet valve is connected to an outlet of the inner-space high-pressure pressure controller inlet valve via the inner-space high-pressure pressure controller, and an inlet of the inner-space high-pressure pressure controller inlet valve serves as the inlet of the inner-space high-pressure pressure control module.

5. The device of claim 4, wherein the outer-space high-pressure pressure control module comprises an outer-space high-pressure pressure controller outlet valve, an outer-space high-pressure pressure controller inlet valve and an outer-space high-pressure pressure controller, which are connected by the pipe, an outlet of the outer-space high-pressure pressure controller outlet valve serves as the outlet of the outer-space high-pressure pressure control module, the outer-space high-pressure pressure controller outlet valve is connected to an outlet of the outer-space high-pressure pressure controller inlet valve via the outer-space high-pressure pressure controller, and an inlet of the outer-space high-pressure pressure controller inlet valve serves as the inlet of the outer-space high-pressure pressure control module.

6. The device of claim 1, wherein the outlets of the inner-space liquid nitrogen inlet valve, the low-pressure pressure control module and the inner-space high-pressure pressure control module are connected in parallel and are connected to the inlet of the inner-space of the thermal insulation module via a first pipe and an inner-space inlet metal hose, and the outlets of the outer-space high-pressure pressure control module and the outer-space liquid nitrogen inlet valve are connected in parallel and connected to the inlet of the outer-space of the thermal insulation module via a second pipe and an outer-space inlet metal hose.

7. The device of claim 6, wherein the outlet of the inner space of the thermal insulation module is connected to the inlet of the inner-space vent valve via a third pipe and an inner-space outlet metal hose, and the outlet of the outer space of the thermal insulation module is connected to the inlet of the outer-space vent valve via a fourth pipe and an outer-space outlet metal hose.

8. The device of claim 1, wherein the outlet of the inner-space vent valve is connected to one end of a fifth pipe, the outlet of the outer-space vent valve is connected to one end of a sixth pipe, and the other end of the fifth pipe and the other end of the sixth pipe are connected in parallel.

9. The device of claim 6, wherein the first pipe is provided thereon with an inner-space inlet pressure sensor and an inner-space inlet temperature sensor, and the second pipe is provided thereon with an outer-space inlet pressure sensor and an outer-space inlet temperature sensor.

10. The device of claim 9, wherein the first pipe is further provided thereon with an inner-space inlet safety valve, and the second pipe is further provided thereon with an outer-space inlet safety valve.

11. The device of claim 7, wherein the third pipe is provided thereon with an inner-space outlet safety valve, and the fourth pipe is provided thereon with an outer-space outlet safety valve.

12. The device of claim 8, wherein the fifth pipe is provided thereon with an inner-space outlet temperature sensor, an inner-space outlet oxygen content sensor and an inner-space outlet dew-point thermometer, and the sixth pipe is provided thereon with an outer-space outlet temperature sensor, an outer-space outlet oxygen content sensor and an outer-space outlet dew-point thermometer.

13. The device of claim 5, wherein the negative-pressure air evacuation valve, the liquid/gaseous nitrogen discharge valve, the inner-space vent valve, the outer-space vent valve, the inner-space liquid nitrogen inlet valve, the low-pressure pressure controller outlet valve, the inner-space high-pressure pressure controller outlet valve, the outer-space high-pressure pressure controller outlet valve and the outer-space liquid nitrogen inlet valve are cryogenic valves operable at a temperature of −196° C.

14. The device of claim 5, wherein the inner-space vent valve, the outer-space vent valve, the inner-space liquid nitrogen inlet valve, the low-pressure pressure controller outlet valve, the inner-space high-pressure pressure controller outlet valve, the outer-space high-pressure pressure controller outlet valve and the outer-space liquid nitrogen inlet valve are pneumatic valves.

15. The device of claim 5, wherein the negative-pressure air evacuation valve, the liquid/gaseous nitrogen discharge valve, the low-pressure pressure controller inlet valve, the inner-space high-pressure pressure controller inlet valve and the outer-space high-pressure pressure controller inlet valve are solenoid valves.

16. The device of claim 5, wherein the negative-pressure air evacuation valve, the liquid/gaseous nitrogen discharge valve, the inner-space vent valve, the outer-space vent valve, the inner-space liquid nitrogen inlet valve, the low-pressure pressure controller outlet valve, the low-pressure pressure controller inlet valve, the inner-space high-pressure pressure controller outlet valve, the inner-space high-pressure pressure controller inlet valve, the outer-space high-pressure pressure controller outlet valve, outer-space high-pressure pressure controller inlet valve and the outer-space liquid nitrogen inlet valve are fixed to the pipe by welding.

17. The device of claim 5, wherein the low-pressure pressure controller, the inner-space high-pressure pressure controller and the outer-space high-pressure pressure controller are fixed to the pipe by vacuum coupling radius seal interfaces.

18. The device of claim 12, wherein the inner-space outlet oxygen content sensor, the inner-space outlet dew-point thermometer, the outer-space outlet oxygen content sensor and the outer-space outlet dew-point thermometer are fixed to the pipe by vacuum coupling radius seal interfaces.

19. The device of claim 9, wherein the inner-space inlet pressure sensor, the inner-space inlet temperature sensor, the outer-space inlet pressure sensor and the outer-space inlet temperature sensor are fixed to the pipe by threaded connections.

20. The device of claim 7, wherein the inner-space inlet metal hose, the outer-space inlet metal hose, the inner-space outlet metal hose and the outer-space outlet metal hose are fixed to the thermal insulation module by vacuum coupling radius seal interfaces, and the inner-space inlet metal hose, the outer-space inlet metal hose, the inner-space outlet metal hose and the outer-space outlet metal hose are fixed to the first pipe, the second pipe, the third pipe and the fourth pipe by welding.
